(19) United States
(12) Patent Application Publication
(10) Pub. No.: US 2013/0202191 A1
(43) Pub. Date: Aug. 8, 2013

(54) MULTI-VIEW IMAGE GENERATING METHOD AND APPARATUS USING THE SAME

(71) Applicant: Tzung-Ren Wang, Tainan City (TW)

(72) Inventor: Tzung-Ren Wang, Tainan City (TW)

(73) Assignee: HIMAX TECHNOLOGIES LIMITED, Tainan City (TW)

(21) Appl. No.: 13/365,032

(22) Filed: Feb. 2, 2012

(51) Int. Cl. G06T 3/00

(52) U.S. Cl. 382/154

(57) ABSTRACT

A multi-view image generating method adapted to a 2D-to-3D conversion apparatus is provided. The multi-view image generating method includes the following steps. A pair of images is received. The pair of images is captured from different angles by a single image capturing apparatus rotating a rotation angle. A disparity map is generated based on one of the pair of images. A remapped disparity map is generated based on the disparity map by using a non-constant function. A depth map is generated based on the remapped disparity map. Multi-view images are generated based on the one of the pair of images and the depth map. Furthermore, a multi-view image generating apparatus adapted to the 2D-to-3D conversion apparatus is also provided.

### BACKGROUND OF THE INVENTION

1. Field of the Invention

The invention relates to an image generating method and an apparatus using the same, and more particularly to a multi-view image generating method and an apparatus using the same.

2. Description of Related Art

Presently, the common method for capturing a 3D image is performed by using a stereo camera having two lenses. The stereo camera consists of two lenses having the same specifications, and a distance between the two lenses is about 7.7 cm, thus simulating an actual distance between a person's eyes. Parameters of the two lenses, such as focal lengths, apertures, and shutters are controlled by a processor of the stereo camera. By triggering through a shutter release, images of the same area but of different perspectives are captured and used for simulating a left-eye image and a right-eye image of a human.

Specifically, the left-eye image and the right-eye image are respectively captured by the two lenses of the stereo camera. Since the two images captured by the stereo camera may be slightly different in angles, the 3D stereoscopic display can generate the depth of field based on the difference and combine the two images to display a 3D image. As long as capturing parameters are adjusted to be consistent with each other, a 3D image with a good imaging effect can be captured. However, in the structure of this type of stereo camera, two groups of lenses and sensors are required, and thus the cost is high. Another method for capturing a 3D image is to capture the image by rotating a single lens camera. However, the most significant problem in the method is that the disparities of the near object and the far object between the two images may appear different from the real 3D image.

Accordingly, an image processing method for compensating disparity or depth of the images captured by the single lens camera to generate multi-view images is necessary.

### SUMMARY OF THE INVENTION

The invention is directed to a multi-view image generating method and an apparatus using the same capable of providing multi-view images to form 3D images consistent with the real world image.

The invention provides a multi-view image generating method adapted to a 2D-to-3D conversion apparatus. The multi-view image generating method includes the following steps. A pair of images is received. The pair of images is captured from different angles by a single image capturing apparatus rotating a rotation angle. A disparity map is generated based on one of the pair of images. A remapped disparity map is generated based on the disparity map by using a non-constant function. A depth map is generated based on the remapped disparity map. Multi-view images are generated based on the one of the pair of images and the depth map.

In an embodiment of the invention, in the step of generating the disparity map based on the pair of images, the disparity map is generated in a manner of stereo matching.

In an embodiment of the invention, in the step of generating multi-view images based on one of the pair of images and the depth map, the multi-view images is generated in a manner of depth image based rendering (DIBR).

The invention provides a multi-view image generating apparatus adapted to a 2D-to-3D conversion apparatus. The multi-view image generating apparatus includes a depth generating unit, a remapping unit, and a multi-view image generating unit. The depth generating unit receives a pair of images captured from different angles by a single image capturing apparatus rotating a rotation angle and generates a disparity map based on one of the pair of images. The remapping unit generates a remapped disparity map based on the disparity map by using a non-constant function. The multi-view image generating unit generates a depth map based on the remapped disparity map and generates multi-view images based on the one of the pair of images and the depth map.

In an embodiment of the invention, the depth generating unit generates the disparity map in a manner of stereo matching.

In an embodiment of the invention, the multi-view image generating unit generates the multi-view images in a manner of depth image based rendering (DIBR).

In an embodiment of the invention, the single image capturing apparatus comprises a single lens camera with a single CMOS (complementary metal oxide semiconductor) image sensor or a dual lens camera with a single CMOS image sensor.

In an embodiment of the invention, the non-constant function is preset in accordance with pupillary distances and the rotation angle.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a left-eye image and a right-eye image respectively captured by a stereo camera consisting of two lenses.

FIG. 2 shows a left-eye image and a right-eye image captured by a single lens camera according to an embodiment of the invention.

FIG. 3 shows a schematic diagram of a multi-view image generating apparatus according to an embodiment of the invention.

FIG. 4 shows a flowchart of a multi-view image generating method according to an embodiment of the invention.

FIG. 5A to FIG. 5C respectively show different non-constant functions according to an embodiment of the invention.

### DESCRIPTION OF EMBODIMENTS

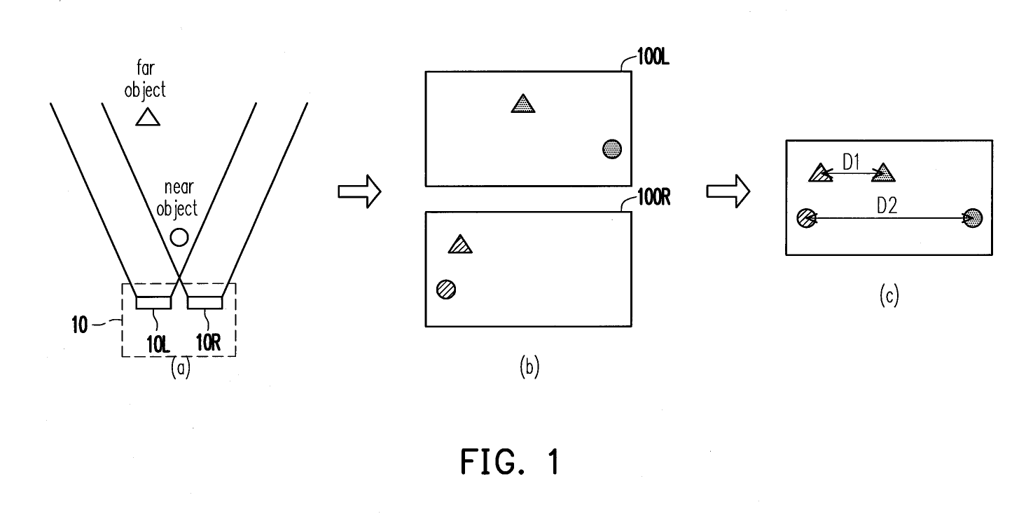

FIG. 1 shows a left-eye image and a right-eye image respectively captured by a stereo camera consisting of two lenses. Referring to FIG. 1, the left-eye image 100L and the right-eye image 100R are 2D images and respectively captured from different points of view by the two lenses 10L and 10R of the stereo camera 10. The two images 100L and 100R are slightly different regarding the distribution of objects. Comparing the left-eye image 100L with the right-eye image 100R, the far object has a disparity D1 in horizontal, and the near object has a disparity D2 in horizontal as shown in FIG. 1(c). In this case, the disparity D2 of the near object is larger than the disparity D1 of the far object, i.e. D2>D1.

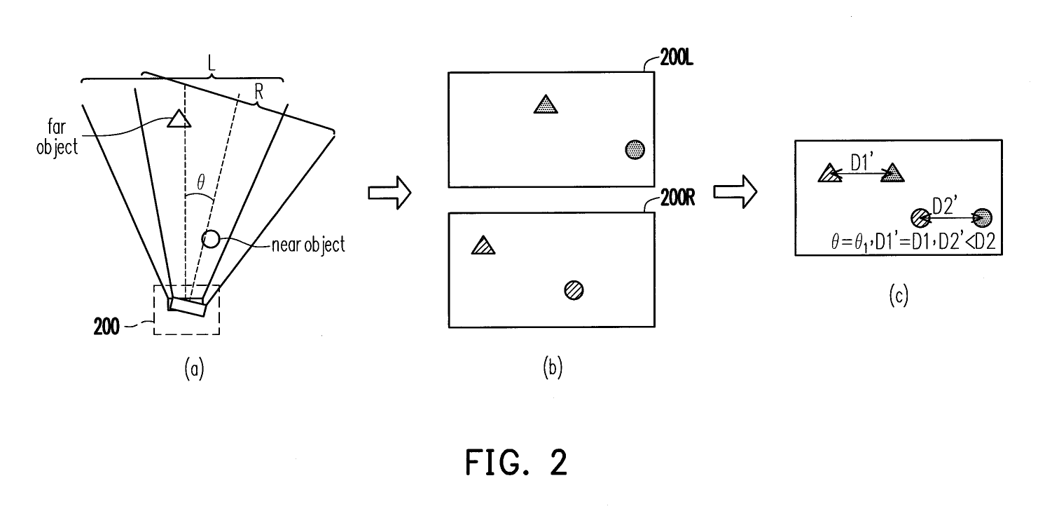

FIG. 2 shows a left-eye image and a right-eye image captured by a single lens camera according to an embodiment of the invention. Referring to FIG. 2, the left-eye image 200L and the right-eye image 200R are captured from different angles by the single-lens camera 200 rotating a rotation angle θ in the present embodiment. The distribution of objects in the left-eye image 200L and the right-eye image 200R is determined based on the rotation angle θ. For a specific case, such as θ=θ₁, the disparity D1′ of the far object is equal to the disparity D1 of the far object, and meanwhile the disparity D2′ of the near object is smaller than the disparity D2 of the near object, i.e. D2′<D2, as shown in FIG. 2(c). However, for a real 3D image, the disparity D2′ of the near object should be equal to the disparity D2 of the near object in this case. For another specific case, such as θ=θ₂ and θ₂>θ₁, the disparity D2′ of the near object is equal to the disparity D2 of the near object, and meanwhile the disparity D1′ of the far object is larger than the disparity D1 of the far object, i.e. D1′>D1. However, for the same real 3D image, the disparity D1′ of the far object should be equal to the disparity D1 of the far object in this case.

In other words, the disparities of objects in the two images captured by the single-lens camera 200 rotating in the region of θ₂>θ>θ₁ appear inversely different from those in the two images captured by the stereo camera 10. Accordingly, in order to display a 3D image to be more consistent with the real world image, an image processing method for compensating disparities or depths of the images captured by the single lens camera to generate multi-view images is necessary.

It should be noted that the single-lens camera 200 is simply equipped with a single CMOS (complementary metal oxide semiconductor) to reduce cost in the present embodiment. Furthermore, the single image capturing apparatus of the invention may include a dual lens camera with a single CMOS image sensor. The dual lens camera with a single CMOS image sensor also has the foregoing issue of disparity inconsistent with the real 3D image.

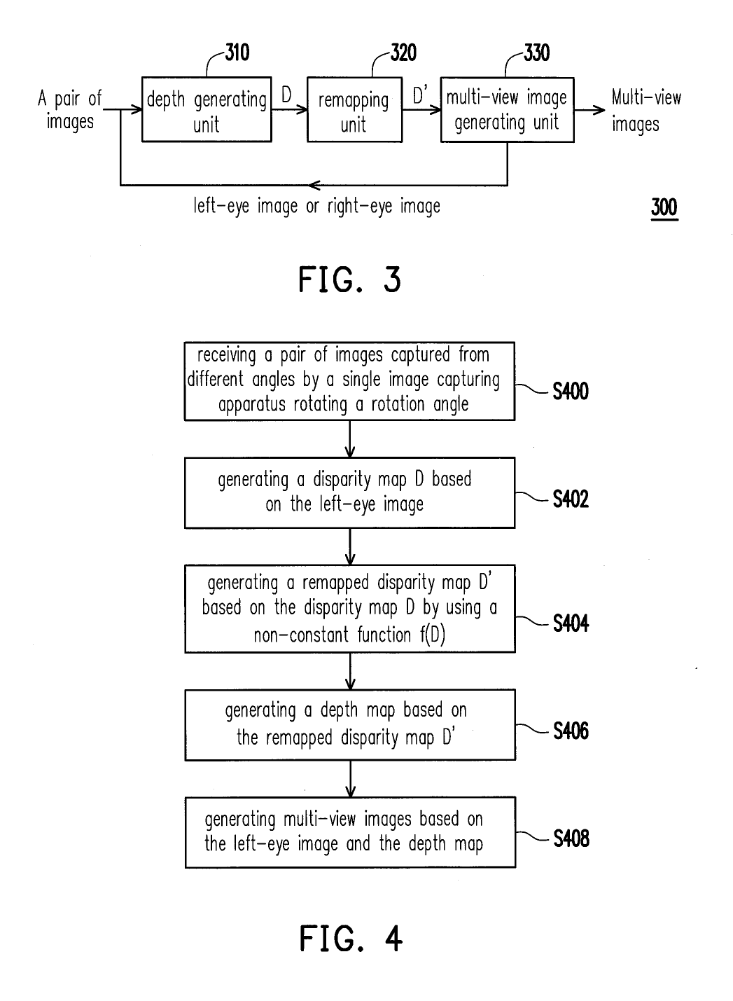

FIG. 3 shows a schematic diagram of a multi-view image generating apparatus according to an embodiment of the invention. FIG. 4 shows a flowchart of a multi-view image generating method according to an embodiment of the invention. The multi-view image generating method of the present embodiment may be applied to the multi-view image generating apparatus 300. The multi-view image generating apparatus 300 of the present embodiment is adapted to a 2D-to-3D conversion apparatus (not shown). By using the multi-view image generating method, the disparities and depths of objects in multi-view images generated by the multi-view image generating apparatus 300 are compensated, so that the 2D-to-3D conversion apparatus can convert the 2D multi-view images into a real 3D image which is more consistent with the real world image.

Referring to FIG. 3 and FIG. 4, the multi-view image generating apparatus 300 includes a depth generating unit 310, a remapping unit 320, and a multi-view image generating unit 330 in the present embodiment. In step S400, the depth generating unit 310 receives a pair of images captured from different angles by a single image capturing apparatus rotating a rotation angle θ. In the present embodiment, the single image capturing apparatus may include a single lens camera equipped with a single CMOS image sensor such as the single-lens camera 200. Alternatively, the single image capturing apparatus may include a dual lens camera equipped with a single CMOS image sensor. For the rotation angle θ, the pair of images, i.e. the left-eye image and the right-eye image, are captured and transmitted to the depth generating unit 310.

Next, in step S402, the depth generating unit 310 generates a disparity map D based on one of the pair of images. In the present embodiment, the left-eye image is exemplary, and thus the disparity map is generated based on the left-eye image, e.g. 200L, in a manner of stereo matching by the depth generating unit 310.

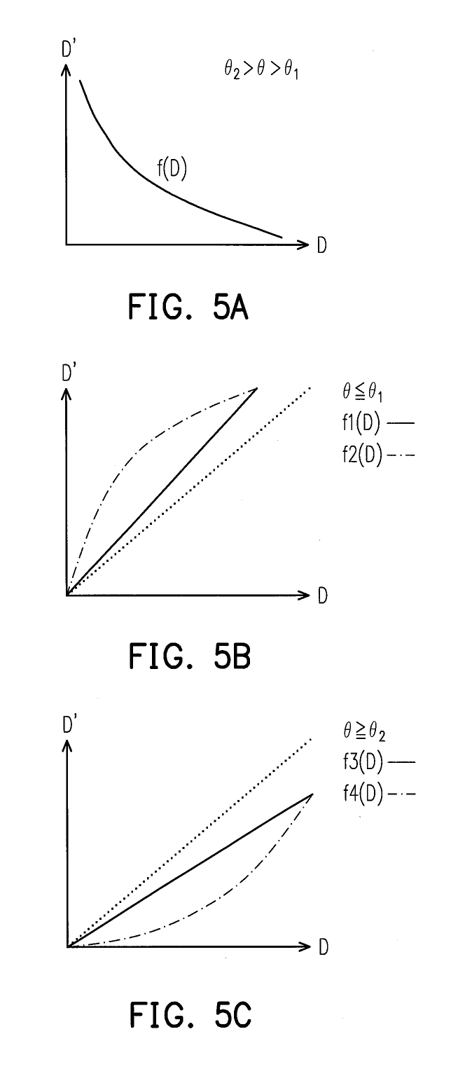

Thereafter, in step S404, the remapping unit 320 generates a remapped disparity map D′ based on the disparity map D by using a non-constant function. Specifically, FIG. 5A to FIG. 5C respectively show different non-constant functions according to an embodiment of the invention. In FIG. 5A, the function illustrates that remapped disparity map D′ is inversely proportional to the disparity map D. When the rotation angle of the single-lens camera 200 is in the region of θ₂>θ>θ₁, the disparities of objects in the two images captured by the single-lens camera 200 appear inversely different from those in the two images captured by the stereo camera 10.

The inversely proportional function f(D) shown in FIG. 5A is utilized to compensate the disparities of objects in the two images captured by the single-lens camera 200. The remapping unit 320 remaps the disparity map D to generate a remapped disparity map D′ based on the inversely proportional function f(D). It should be noted that the non-constant function is not limited to the inversely proportional function f(D) shown in FIG. 5A. In other embodiments, for compensating the disparities of objects, the non-constant function may be enough. In the present embodiment, the non-constant function is preset in accordance with pupillary distances and the rotation angle. By experiment, non-constant functions can be determined based on pupillary distances for different rotation angles in one-to-one manner. Each rotation angle has its corresponding non-constant function to compensate the disparities of objects captured in each rotation angle.

It should be noted that the multi-view image generating apparatus of the present embodiment can also applied to images captured by the single-lens camera 200 rotating in the region θ≦θ₁ or θ≧θ₂. For the region θ≦θ₁, the disparity map D should be increased such that the non-constant function f1 (D) or f2(D) is set for mapping operation. The non-constant function f1 (D) has a constant slope, and the non-constant function f2(D) has a variable slope as shown in FIG. 5B. On the contrary, for the region θ≧θ₂, the disparity map D should be decreased such that the non-constant function f3(D) or f4(D) is set for mapping operation. The non-constant function f3(D) has a constant slope, and the non-constant function f4(D) has a variable slope as shown in FIG. 5C. Therefore, the non-constant function is optionally changed to a suitable one, and it may be determined by experiment.

Next, in step S406, the multi-view image generating unit 330 generates a depth map based on the remapped disparity map D′, and then in step S408, the multi-view image generating unit 330 generates multi-view images based on the left-eye image and the depth map generated in step S406. In step S408, the multi-view image generating unit 330 may generate the multi-view images in a manner of depth image based rendering (DIBR). In the present embodiment, the multi-view images are generated based on the left-eye image, but the invention is not limited thereto. In another embodiment, the multi-view images may be generated based on the right-eye image.

In summary, in the exemplary embodiments of the invention, the multi-view image generating apparatus compensates the disparities of objects in images captured by the single lens camera or the dual lens camera equipped with a single CMOS image sensor by using a non-constant function. Accordingly, the generated multi-view images are converted into a 3D image which is more consistent with the real world image, and also a good image quality is provided.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A multi-view image generating method, adapted to a 2D-to-3D conversion apparatus, the multi-view image generating method comprising:
receiving a pair of images captured from different angles by a single image capturing apparatus rotating a rotation angle;
generating a disparity map based on one of the pair of images;
generating a remapped disparity map based on the disparity map by using a non-constant function;
generating a depth map based on the remapped disparity map; and
generating multi-view images based on the one of the pair of images and the depth map.

2. The multi-view image generating method according to claim 1, wherein the single image capturing apparatus comprises a single lens camera with a single CMOS (complementary metal oxide semiconductor) image sensor or a dual lens camera with a single CMOS image sensor.

3. The multi-view image generating method according to claim 1, wherein in the step of generating the disparity map based on the pair of images, the disparity map is generated in a manner of stereo matching.

4. The multi-view image generating method according to claim 1, wherein in the step of generating multi-view images based on one of the pair of images and the depth map, the multi-view images is generated in a manner of depth image based rendering (DIBR).

5. The multi-view image generating method according to claim 1, wherein the non-constant function is preset in accordance with pupillary distances and the rotation angle.

6. A multi-view image generating apparatus, adapted to a 2D-to-3D conversion apparatus, the multi-view image generating apparatus comprising:
a depth generating unit receiving a pair of images captured from different angles by a single image capturing apparatus rotating a rotation angle and generating a disparity map based on one of the pair of images;
a remapping unit generating a remapped disparity map based on the disparity map by using a non-constant function; and
a multi-view image generating unit generating a depth map based on the remapped disparity map and generating multi-view images based on the one of the pair of images and the depth map.

7. The multi-view image generating apparatus according to claim 7, wherein the single image capturing apparatus comprises a single lens camera with a single CMOS (complementary metal oxide semiconductor) image sensor or a dual lens camera with a single CMOS image sensor.

8. The multi-view image generating apparatus according to claim 7, wherein the depth generating unit generates the disparity map in a manner of stereo matching.

9. The multi-view image generating apparatus according to claim 7, wherein the multi-view image generating unit generates the multi-view images in a manner of depth image based rendering (DIBR).

10. The multi-view image generating apparatus according to claim 7, wherein the non-constant function is preset in accordance with pupillary distances and the rotation angle.
